(19) United States
(12) Patent Application Publication
(10) Pub. No.: US 2025/0381953 A1
(43) Pub. Date: Dec. 18, 2025

(54) VEHICLE CONTROL DEVICE AND VEHICLE CONTROL METHOD

(71) Applicants: TOYOTA JIDOSHA KABUSHIKI KAISHA, Aichi-ken (JP); DENSO CORPORATION, Aichi-pref (JP)

(72) Inventors: Masaho ISHIDA, Toyota-shi (JP); Hiroaki IIDA, Hashima-shi (JP); Issei MATSUNAGA, Nagoya-shi (JP)

(21) Appl. No.: 19/082,176

(22) Filed: Mar. 18, 2025

(30) Foreign Application Priority Data
Jun. 14, 2024 (JP) 2024-096808

(51) Int. Cl. B60W 30/09; B60W 30/095; B60W 50/14; E05B 77/08

(52) U.S. Cl. CPC B60W 30/09; B60W 30/0956; B60W 50/14; E05B 77/08; B60W 2050/143; B60W 2050/146; B60W 2300/14; B60W 2530/203; B60W 2554/4041

(57) ABSTRACT

A vehicle control device that controls an operation of a vehicle includes: a moving body detection unit that detects a moving body present behind the vehicle; an operation unit that performs, when the moving body detected by the moving body detection unit is estimated to pass a side of a door of the vehicle, a contact avoidance operation including at least one of restriction of opening of the door and warning to an occupant of the vehicle; and a towing determination unit that determines whether or not a trailer is connected to the vehicle. When it is determined that the trailer is connected to the vehicle, the operation unit restrains the contact avoidance operation as compared with a case where it is determined that the trailer is not connected to the vehicle.

### CROSS-REFERENCE TO RELATED APPLICATION

This application claims priority to Japanese Patent Application No. 2024-096808 filed on Jun. 14, 2024, incorporated herein by reference in its entirety.

### BACKGROUND

### 1. Technical Field

The present disclosure relates to a vehicle control device and a vehicle control method.

### 2. Description of Related Art

Hitherto, a device that detects another vehicle around an own vehicle and notifies, when the detected other vehicle approaches the own vehicle, an occupant that the other vehicle is approaching has been known (Japanese Unexamined Patent Application Publication No. 2023-163805 (JP 2023-163805 A), Japanese Unexamined Patent Application Publication No. 2016-045838 (JP 2016-045838 A)). In particular, in the device described in JP 2023-163805 A, when a sensor that detects an object positioned behind the own vehicle detects the other vehicle approaching the own vehicle, the notification to the occupant is performed.

### SUMMARY

Incidentally, in a case where the vehicle tows a trailer, when the sensor that detects the object positioned behind the own vehicle is used, an object positioned at a place different from behind the vehicle may be erroneously detected as an object positioned behind the vehicle due to reflection on the surface of the trailer. As a result, for example, the notification to the occupant is unnecessarily performed, and the occupant may feel bothered.

In view of the above-mentioned problem, the present disclosure has an object to reduce erroneous detection of a moving body present behind a vehicle when the vehicle tows a trailer.

The summary of the present disclosure is as follows.

(1) A first aspect of the disclosure relates to a vehicle control device that controls an operation of a vehicle, the vehicle control device including:
a moving body detection unit that detects a moving body present behind the vehicle;
an operation unit that performs, when the moving body detected by the moving body detection unit is estimated to pass a side of a door of the vehicle, a contact avoidance operation including at least one of restriction of opening of the door and warning to an occupant of the vehicle; and
a towing determination unit that determines whether a trailer is connected to the vehicle. When determination is made that the trailer is connected to the vehicle, the operation unit restrains the contact avoidance operation as compared with a case where determination is made that the trailer is not connected to the vehicle.

(2) In the vehicle control device according to Item (1), when determination is made that the trailer is connected to the vehicle, the operation unit does not perform the contact avoidance operation.

(3) In the vehicle control device according to Item (1), when determination is made that the trailer is connected to the vehicle, the operation unit performs the warning to the occupant of the vehicle but does not restrict the opening of the door.

(4) In the vehicle control device according to Item (1), when determination is made that the trailer is connected to the vehicle, the operation unit does not perform the contact avoidance operation until the moving body comes closer to the vehicle as compared with the case where determination is made that the trailer is not connected to the vehicle.

(5) A second aspect of the disclosure relates to a vehicle control method of controlling an operation of a vehicle, the vehicle control method including:
detecting a moving body present behind the vehicle;
executing, when the detected moving body is estimated to pass a side of a door of the vehicle, a contact avoidance operation including at least one of restriction of opening of the door and warning to an occupant of the vehicle; and
determining whether a trailer is connected to the vehicle. When determination is made that the trailer is connected to the vehicle, the contact avoidance operation is restrained as compared with a case where determination is made that the trailer is not connected to the vehicle.

According to the present disclosure, it is possible to reduce erroneous detection of the moving body present behind the vehicle when the vehicle tows the trailer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating a vehicle including a vehicle control system 1 and a trailer;

FIG. 2 is a block diagram schematically illustrating a configuration of the vehicle control system;

FIG. 3 is a functional block diagram of a processor of an ECU;

FIG. 4 is an explanatory view of a moving body detected by a moving body detection unit;

FIG. 5 is a view illustrating a situation around the vehicle when an oncoming vehicle travels from forward of the vehicle on a lane adjacent to a lane on which the vehicle is stopped;

FIG. 6 is a flowchart illustrating a flow of control processing according to a first embodiment; and

FIG. 7 is a flowchart illustrating a flow of control processing according to a second embodiment.

### DETAILED DESCRIPTION OF EMBODIMENTS

Hereinafter, details of embodiments are described with reference to the drawings. It is to be noted that, in the following description, similar components are denoted by the same reference numerals.

### First Embodiment

### Configuration of Vehicle Control System

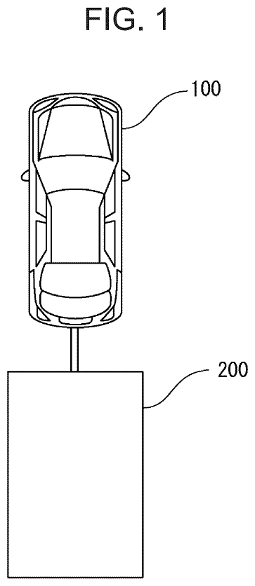

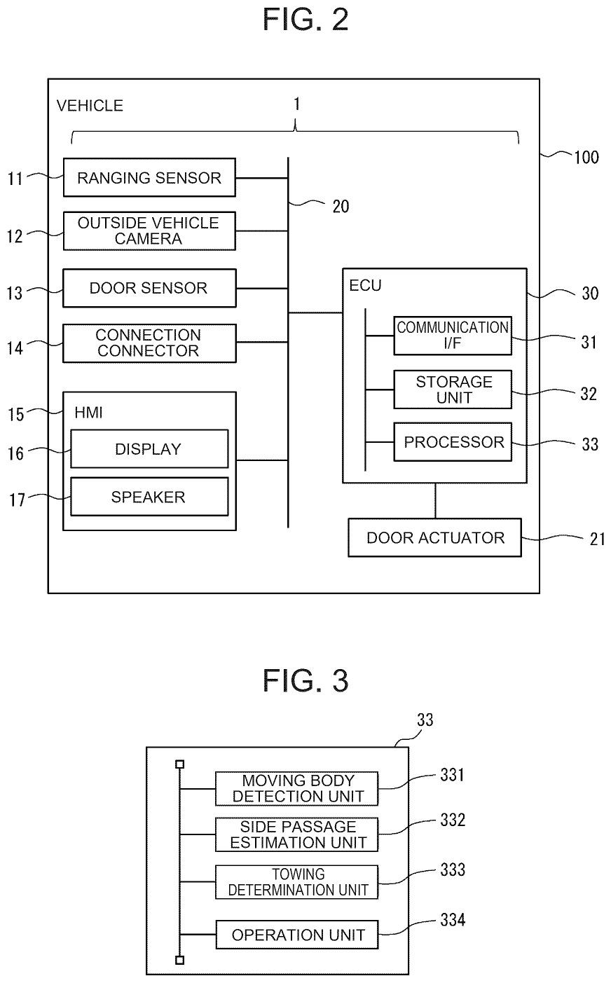

With reference to FIG. 1 and FIG. 2, description is given of a configuration of a vehicle control system 1 equipped with a vehicle control device according to a first embodiment. FIG. 1 is a schematic view illustrating a vehicle 100 including the vehicle control system 1 and a trailer 200.

As illustrated in FIG. 1, the vehicle 100 is configured to be capable of towing the trailer 200. The vehicle 100 includes metal fittings for use in attaching the trailer 200, and metal fittings of the trailer 200 are attached to the metal fittings.

In this embodiment, the vehicle 100 is not a vehicle having a main purpose of towing such as a trailer head, but a vehicle not having a main purpose of towing, for example, a passenger car. Further, the trailer 200 is, for example, as illustrated in FIG. 1, a camping trailer that provides a living space. However, the trailer 200 may be any trailer as long as the trailer can be towed by a passenger car or the like, such as a boat trailer on which water equipment is placed, a motorcycle trailer on which a motorcycle is placed, or a multi-trailer that can be loaded with various things.

FIG. 2 is a block diagram schematically illustrating the configuration of the vehicle control system 1. The vehicle control system 1 is installed on the vehicle 100, and controls the operation of the vehicle 100. As illustrated in FIG. 2, the vehicle control system 1 includes a ranging sensor 11, an outside vehicle camera 12, a door sensor 13, a connection connector 14, a human-machine interface (HMI) 15, a door actuator 21, and an electronic control unit (hereinafter referred to as “ECU”) 30. The ranging sensor 11, the outside vehicle camera 12, the door sensor 13, the connection connector 14, the HMI 15, and the ECU 30 are communicably connected via, for example, an in-vehicle network 20. The in-vehicle network 20 is, for example, a network complying with a standard such as a controller area network (CAN). Further, the ECU 30 is connected to the door actuator 21 via a signal line.

The ranging sensor 11 is an example of a surrounding environment sensor that detects an environment or a situation around the vehicle 100 to generate surrounding environment data indicating the environment or the situation around the vehicle 100. The ranging sensor 11 measures the distance to an object present around the vehicle 100. In this embodiment, the ranging sensor 11 can also measure the direction of the object present around the vehicle 100. Examples of the ranging sensor 11 include a radar such as a millimeter wave radar, a LiDAR, and a SONAR. In this embodiment, the ranging sensor 11 measures the distance to the object present behind the vehicle 100. The ranging sensor 11 outputs, via the in-vehicle network 20, a measurement result of the distance to the object around the vehicle 100 to the ECU 30 for each predetermined period.

The outside vehicle camera 12 is an example of the surrounding environment sensor. The outside vehicle camera 12 images a region around the vehicle 100, and, in this embodiment, images a region behind the vehicle 100. Examples of the outside vehicle camera 12 include a CCD camera and a CMOS camera having sensitivity to visible light. The outside vehicle camera 12 images a front region of the vehicle 100 for each predetermined imaging period, and generates image data including the imaged front region. It is to be noted that the outside vehicle camera 12 may be a monocular camera or a stereo camera. When a stereo camera is used as the outside vehicle camera 12, the outside vehicle camera 12 also functions as the ranging sensor 11.

The door sensor 13 is an example of a sensor that detects a state of a door of the vehicle 100. The door sensor detects, for example, whether or not an opening operation of the door has been performed by the occupant and whether or not the door is locked. The door sensor 13 is provided in each door of the vehicle 100, and outputs whether or not the opening operation of the corresponding door has been performed and whether or not the corresponding door is locked. The door sensor 13 outputs, via the in-vehicle network 20, the detection result for each door of the vehicle 100 to the ECU 30 for each predetermined period.

The connection connector 14 is a connector to be connected to a connection connector of the trailer 200 when the trailer 200 is connected to the vehicle 100. Various signals are transmitted to the trailer 200 from the ECU 30 of the vehicle 100 via the connection connector 14, and electric power is supplied to the trailer 200. In this manner, for example, in accordance with the operation of the driver of the vehicle 100, a direction indicator of the trailer 200 is blinked or a brake light is turned on. The connection connector 14 is connected to the ECU 30 via the in-vehicle network 20, and is used for transmitting a signal transmitted from the ECU 30 to the trailer 200.

The HMI 15 is an interface for inputting and outputting information between the vehicle control system 1 and the driver or the passenger. The HMI 15 includes an information providing device that provides various types of information to the driver or the passenger, and an input device for use in performing an input operation by the driver or the passenger.

Specifically, the HMI 15 includes, as the information providing device, a display 16 that displays letter information or image information. The display 16 is an example of a display device that displays an image. The display 16 is display equipment of any type, such as a liquid crystal display or an OLED display. The display 16 is disposed on, for example, an instrument panel or a meter panel of the vehicle 100. The display 16 receives an image signal from the ECU 30 via the in-vehicle network 20, and displays an image in accordance with the image signal.

Further, the HMI 15 includes a speaker 17 as the information providing device. The speaker 17 is an example of equipment that outputs audio. The speaker 17 receives, via the in-vehicle network 20, an audio signal from the ECU 30, and outputs audio in accordance with the audio signal. It is to be noted that the HMI 15 may include, as the information providing device, equipment other than the display 16 and the speaker 17 that provides various types of information to the driver or the passenger (for example, a vibration device).

The door actuator 21 controls the state of the door of the vehicle 100. The door actuator 21 is provided in each door, and controls the state of each door in accordance with a control signal transmitted from the ECU 30 via a signal line. The door actuator 21 controls, for example, the lock of the door of the vehicle 100. Further, the door actuator 21 controls, for example, the opening of the door. For example, when the door sensor 13 detects that the opening operation of the door has been performed by the occupant, the door actuator 21 opens the door in accordance with a control signal from the ECU 30.

### Configuration of Vehicle Control Device

The ECU 30 functions as a vehicle control device that controls the operation of the vehicle 100, in particular, the operations of the door actuator 21 and the HMI 15 of the vehicle 100. Further, the ECU 30 executes a vehicle control method of controlling the operation of the vehicle 100. As illustrated in FIG. 2, the ECU 30 includes a communication interface 31, a storage unit 32, and a processor 33.

The communication interface 31 is a circuit for use in connecting the ECU 30 to the in-vehicle network 20.

The storage unit 32 is an example of a non-transitory storage medium that stores data. The storage unit 32 includes, for example, at least one of a volatile semiconductor memory, a non-volatile semiconductor memory, a hard disk drive (HDD), and a solid state drive (SSD). The storage unit 32 stores a computer program to be executed by the processor 33 of the ECU 30. Further, the storage unit 32 stores data to be used by the computer program executed by the processor 33, such as data transmitted from various sensors.

The processor 33 includes one or more central processing units (CPUs) and peripheral circuits thereof. The processor 33 may further include other operation circuits, such as a logical operation unit and a numerical operation unit. The processor 33 executes various types of processing based on the computer program stored in the storage unit 32.

FIG. 3 is a functional block diagram of the processor 33 of the ECU 30. As illustrated in FIG. 3, the processor 33 includes a moving body detection unit 331, a side passage estimation unit 332, a towing determination unit 333, and an operation unit 334. Each of the units included in the processor 33 is, for example, a functional module to be implemented by the computer program operating on the processor 33. Alternatively, each of the units included in the processor 33 may be mounted on the ECU 30 as an independent integrated circuit, microprocessor, or firmware.

The moving body detection unit 331 detects a moving body present behind the vehicle 100. The moving body detection unit 331 detects the moving body present behind the vehicle 100 based on the surrounding environment data generated by the ranging sensor 11 or the outside vehicle camera 12. In this embodiment, the moving body detection unit 331 detects a relative position with respect to the vehicle 100 of a moving body moving behind the vehicle 100, a moving direction of the moving body, and a moving speed of the moving body.

In this embodiment, the moving body detection unit 331 sequentially inputs, to a discriminator, detection data received from the ranging sensor 11 or image data received from the outside vehicle camera 12 to detect the relative position, the moving direction, and the moving speed of the moving body represented in the detection data or the image data. The discriminator is, for example, a convolutional neural network (CNN) including a plurality of convolutional layers connected in series from the input side to the output side.

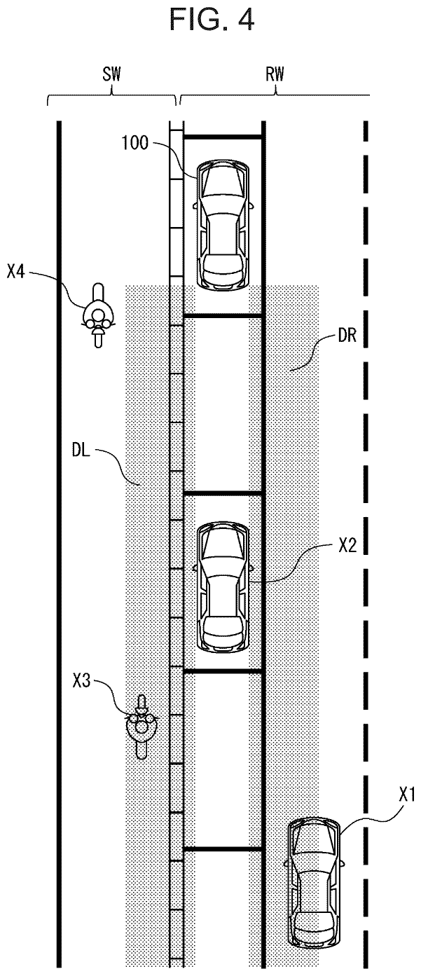

In particular, in this embodiment, as illustrated in FIG. 4, the moving body detection unit 331 detects the moving body positioned rearward and sideward of the vehicle 100. FIG. 4 is an explanatory view of a moving body detected by the moving body detection unit 331. In the example illustrated in FIG. 4, the vehicle 100 is stopped in a parking space provided on a roadway RW. Further, on the roadway RW, another vehicle X1 travels on a travel lane adjacent to the parking space in which the vehicle 100 is stopped, in a direction of approaching the vehicle 100 from behind the vehicle 100. In addition, another different vehicle X2 is stopped in a parking space behind the vehicle 100. Further, on a sidewalk SW adjacent to the parking space in which the vehicle 100 is stopped, a bicycle X3 travels in a direction of approaching the vehicle 100 from behind the vehicle 100. In addition, another bicycle X4 travels in a direction of separating from the vehicle 100 behind the vehicle 100.

In this embodiment, the moving body detection unit 331 detects a moving body positioned in a region indicated by hatching in FIG. 4, that is, a region DL leftward and rearward of the vehicle 100 and a region DR rightward and rearward of the vehicle 100. In the example illustrated in FIG. 4, the bicycle X3 is positioned within the detection region DL leftward and rearward of the vehicle 100, and hence the bicycle X3 is detected as the moving body by the moving body detection unit 331. Further, the other vehicle X1 is positioned within the detection region DR rightward and rearward of the vehicle 100, and hence the other vehicle X1 is detected as the moving body by the moving body detection unit 331.

The side passage estimation unit 332 estimates whether or not the moving body detected by the moving body detection unit 331 passes sideward of the vehicle 100, in particular, the side of the door of the vehicle 100. In this embodiment, the side passage estimation unit 332 estimates whether or not the moving body passes sideward of the vehicle 100 while the vehicle 100 is stopped. In addition, when it is estimated that the moving body passes the side of the door of the vehicle 100, the side passage estimation unit 332 estimates an expected time required until passage of the moving body.

In this embodiment, the side passage estimation unit 332 estimates whether or not the moving body passes the side of the door of the vehicle 100 based on the relative position and the moving direction of the moving body detected by the moving body detection unit 331. When the moving body detected by the moving body detection unit 331 moves in a direction of approaching the side of the door of the vehicle 100, the side passage estimation unit 332 estimates that the moving body passes the side of the door of the vehicle 100. Further, the side passage estimation unit 332 estimates the expected time required until the moving body passes the side of the door of the vehicle based on a relative distance between the vehicle 100 and the moving body and the moving speed of the moving body.

The towing determination unit 333 determines whether or not the trailer 200 is connected to the vehicle 100. In this embodiment, the towing determination unit 333 determines whether or not the connection connector of the trailer 200 is connected to the connection connector 14 of the vehicle 100. In addition, when it is determined that the connection connector of the trailer 200 is connected to the connection connector 14 of the vehicle 100, the towing determination unit 333 determines that the trailer 200 is connected to the vehicle 100. Meanwhile, when it is determined that the connection connector of the trailer is not connected to the connection connector 14 of the vehicle 100, the towing determination unit 333 determines that the trailer 200 is not connected to the vehicle 100.

It is to be noted that the towing determination unit 333 may perform the determination based on equipment other than the connection connector 14 as long as the towing determination unit 333 can determine whether or not the trailer 200 is connected to the vehicle 100. For example, the towing determination unit 333 may determine whether or not the trailer 200 is connected to the vehicle 100 based on the image acquired from the outside vehicle camera 12 that images the rear side of the vehicle 100. In this case, the image acquired from the outside vehicle camera 12 is input to the discriminator that identifies the presence or absence of the trailer 200. Alternatively, the towing determination unit 333 may determine whether or not the trailer 200 is connected to the vehicle 100 based on input information input by the driver through the input device of the HMI 15. In this case, when the driver inputs that the trailer 200 has been connected to the vehicle 100 via the input device of the HMI 15, the towing determination unit 333 determines that the trailer 200 is connected to the vehicle 100.

When it is estimated that the moving body detected by the moving body detection unit 331 passes the side of the door of the vehicle 100, the operation unit 334 restricts the opening of the door of the vehicle 100 and performs warning to the occupant of the vehicle 100 (hereinafter, those operations are also collectively referred to as “contact avoidance operation”). In this embodiment, when it is estimated by the side passage estimation unit 332 that the moving body passes the side of the door of the vehicle 100 within a predetermined reference time, the operation unit 334 performs the contact avoidance operation. The reference time may be a constant time determined in advance, or may be a time that changes depending on a value of any parameter, such as the detected moving speed of the moving body. For example, the reference time is set to be shorter as the detected moving speed of the moving body is faster. The reason for this setting is because the braking performance is generally higher as the moving body is faster.

Specifically, for example, when it is estimated that the moving body passes the side of the door of the vehicle 100 within the reference time, the operation unit 334 controls the door actuator 21 of the door so as to prevent the door from being opened. That is, in this case, the operation unit 334 locks the door. Alternatively, the operation unit 334 controls an opening mechanism of the door so that the corresponding door is prevented from being opened even when the occupant operates a lever for opening the door. Further, for example, when it is estimated that the moving body passes the side of the door of the vehicle 100 within the reference time, the operation unit 334 warns the occupant of the vehicle 100 that the moving body is expected to pass the side of the door. Specifically, in this case, the operation unit 334 causes the display 16 to display the fact that the moving body is expected to pass the side of the door and outputs audio indicating this fact from the speaker 17.

It is to be noted that, in this embodiment, when it is estimated that the moving body passes the side of the door of the vehicle 100 within the reference time, the operation unit 334 restricts the opening of the door and performs warning to the occupant. However, in this case, the operation unit 334 may only perform any one of the restriction of the opening of the door and the warning to the occupant as the contact avoidance operation.

Operation when Trailer is Connected

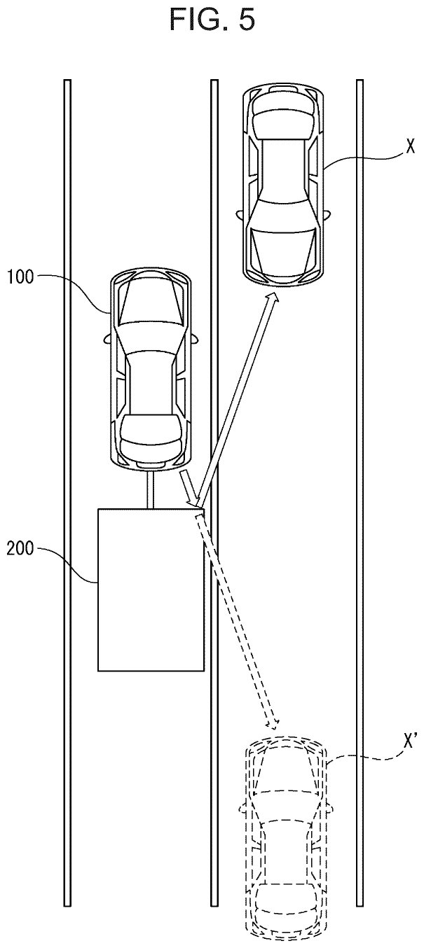

FIG. 5 is a view illustrating a situation around the vehicle 100 when an oncoming vehicle X travels from forward the vehicle 100 on a lane adjacent to the lane on which the vehicle 100 is stopped. When a millimeter wave radar is used as the ranging sensor 11, depending on the shape or the material of the front surface of the trailer 200, as indicated by the solid line of FIG. 5, some millimeter waves radiated from the ranging sensor 11 are reflected by the front surface of the trailer 200. Then, in some cases, the millimeter waves reflected by the front surface of the trailer 200 are reflected by the oncoming vehicle X, and are reflected again by the front surface of the trailer 200 to reach the ranging sensor. In this case, the oncoming vehicle X is detected by the ranging sensor 11 as being positioned rearward and sideward of the vehicle 100 as indicated by the broken line X′ of FIG. 5.

As described above, when the detection waves radiated from the ranging sensor 11 are reflected by the front surface of the trailer 200, the ranging sensor 11 erroneously detects the moving body not positioned rearward and sideward of the vehicle 100 as being positioned rearward and sideward of the vehicle 100. As a result, the opening of the door of the vehicle 100 is unnecessarily restricted and the warning to the occupant is unnecessarily performed, and thus the occupant may feel bothered.

In view of the above, in this embodiment, when the towing determination unit 333 determines that the trailer 200 is connected to the vehicle 100, the operation unit 334 restrains the contact avoidance operation as compared with the case where it is determined that the trailer 200 is not connected to the vehicle 100. For example, when the towing determination unit 333 determines that the trailer 200 is not connected to the vehicle 100, the operation unit 334 performs the contact avoidance operation as described above when the side passage estimation unit 332 estimates that the moving body passes the side of the door of the vehicle 100 within the reference time. Meanwhile, when the towing determination unit 333 determines that the trailer 200 is connected to the vehicle 100, the operation unit 334 does not perform the contact avoidance operation even when the side passage estimation unit 332 estimates that the moving body passes the side of the door of the vehicle 100 within the reference time. Thus, the operation unit 334 does not restrict the opening of the door, and does not perform the warning to the occupant of the vehicle 100. As a result, the opening of the door of the vehicle 100 is prevented from being unnecessarily restricted, and the warning to the occupant is prevented from being unnecessarily performed. Thus, the occupant may be prevented from feeling bothered.

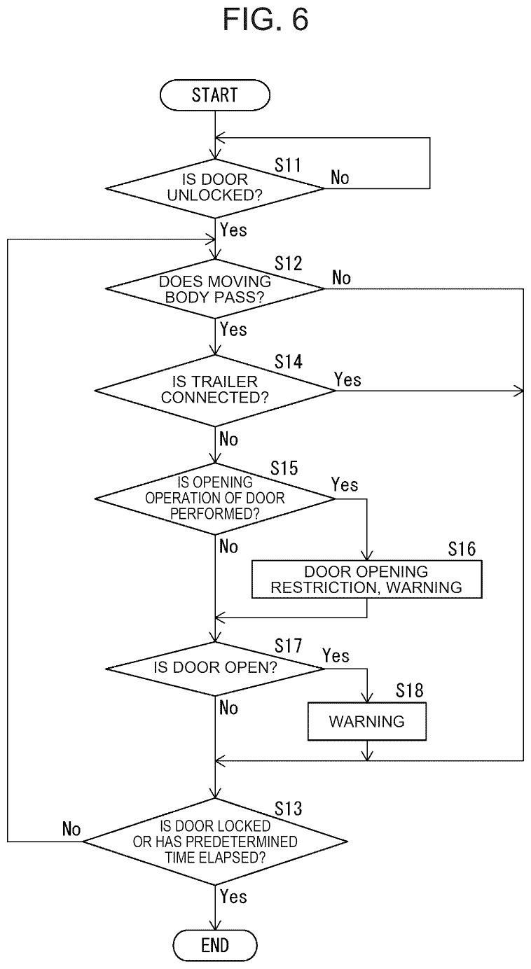

FIG. 6 is a flowchart illustrating a flow of control processing of performing control of the contact avoidance operation. The illustrated control processing is performed by the processor 33 of the ECU 30 when the door of the vehicle 100 is locked.

When the control processing is started, first, the operation unit 334 detects whether or not the door of the vehicle 100 is unlocked based on the detection result from the door sensor 13 (step S11). When it is determined in step S11 that all doors of the vehicle 100 are not unlocked, step S11 is repeated.

When it is determined in step S11 that the door of the vehicle 100 is unlocked, the operation unit 334 determines whether the side passage estimation unit 332 estimates that the moving body detected by the moving body detection unit 331 passes the side of the unlocked door within the reference time (step S12). When it is determined in step S12 that the moving body is not estimated to pass the side of the door within the reference time, the operation unit 334 determines whether or not the unlocked door is locked again by the occupant, and whether or not a predetermined time (for example, three minutes) has elapsed from the determination in step S11 that the door has been unlocked (step S13). When it is determined in step S13 that the unlocked door is not locked again by the occupant and it is determined in step S13 that the predetermined time has not elapsed from the determination that the door has been unlocked, step S12 is repeated. Meanwhile, when it is determined in step S13 that the unlocked door is locked again by the occupant or it is determined in step S13 that the predetermined time has elapsed from the determination that the door has been unlocked, the control processing is ended.

Meanwhile, when it is determined in step S12 that the moving body is estimated to pass the side of the door within the reference time, the towing determination unit 333 determines whether or not the trailer 200 is connected (step S14). When it is determined in step S14 that the trailer 200 is connected, the operation unit 334 determines whether or not the door is locked again by the occupant and whether or not the predetermined time has elapsed from the unlocking (step S13). Thus, no restriction of the opening of the door or no warning to the occupant is performed.

Meanwhile, when it is determined in step S14 that the trailer 200 is not connected, the operation unit 334 determines whether or not the door is closed and the opening operation of the door is performed by the occupant, based on the detection result from the door sensor 13 (step S15). When it is determined in step S15 that the opening operation of the door is performed by the occupant, the operation unit 334 causes the door actuator 21 to restrict the opening of the corresponding door (step S16). Thus, the door is not opened even when the opening operation of the door is performed by the occupant. Further, the operation unit 334 warns the occupant of the vehicle 100 that the moving body is expected to pass the side of the door (step S16). Specifically, the operation unit 334 causes the display 16 to display this fact and outputs audio indicating this fact from the speaker 17.

Next, the operation unit 334 determines whether or not the door is open based on the detection result from the door sensor 13 (step S17). When it is determined in step S17 that the door is open, the operation unit 334 warns the occupant of the vehicle 100 that the moving body is expected to pass the side of the door (step S18). After that, the operation unit 334 determines whether or not the door is locked again by the occupant and whether or not the predetermined time has elapsed from the unlocking (step S13).

### Second Embodiment

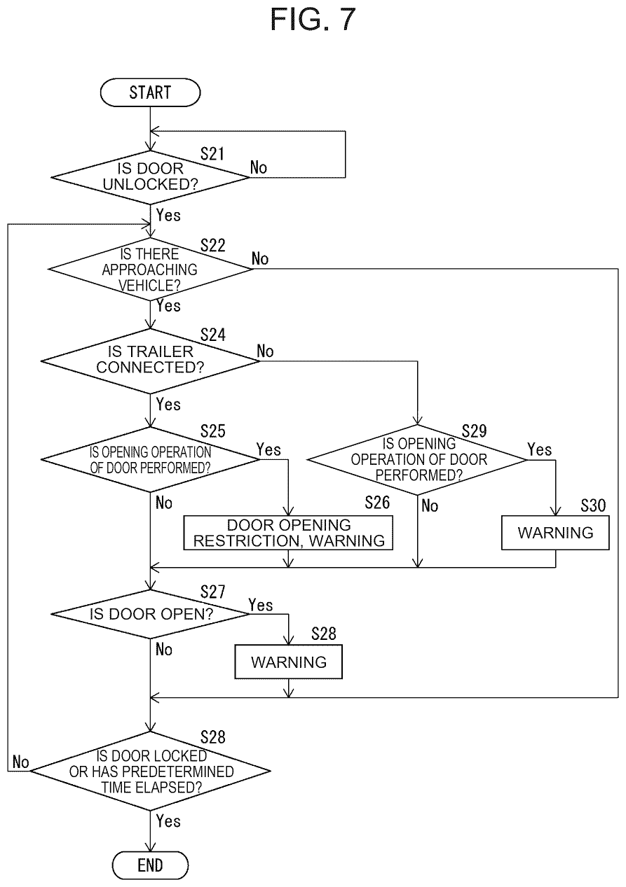

Next, with reference to FIG. 7, a vehicle control system 1 according to a second embodiment is described. The configuration and control of the vehicle control system 1 according to the second embodiment are similar to the configuration and control of the vehicle control system 1 according to the first embodiment. In the following, differences from the vehicle control system 1 according to the first embodiment are mainly described.

In the vehicle control system 1 according to the first embodiment, when the towing determination unit 333 determines that the trailer 200 is connected to the vehicle 100, the operation unit 334 cancels both of the restriction of the opening of the door and the warning to the occupant. In contrast, in this embodiment, when it is determined that the trailer 200 is connected to the vehicle 100, the operation unit 334 performs the warning to the occupant of the vehicle 100, and does not restrict the opening of the door.

Specifically, also in this embodiment, when the towing determination unit 333 determines that the trailer 200 is not connected to the vehicle 100, the operation unit 334 performs the contact avoidance operation as described above when the side passage estimation unit 332 estimates that the moving body passes the side of the door of the vehicle 100 within the reference time. Thus, the opening of the door is restricted, and the warning to the occupant of the vehicle 100 is performed. Meanwhile, when it is determined that the trailer 200 is connected to the vehicle 100, the operation unit 334 does not restrict the opening of the door even when the moving body is estimated to pass the side of the door of the vehicle 100 within the reference time. However, when it is determined that the trailer 200 is connected to the vehicle 100, the operation unit 334 performs the warning to the occupant of the vehicle 100 when the moving body is estimated to pass the side of the door of the vehicle 100 within the reference time.

In this case, when the unnecessary restriction of the opening of the door and the unnecessary warning to the occupant are compared, it is highly possible that the occupant feels more bothered about the unnecessary restriction of the opening of the door. In this embodiment, when the trailer 200 is connected to the vehicle 100, the restriction of the opening of the door is canceled so that, while the occupant is prevented from feeling more bothered, the occupant can be notified of the approach of the moving body by performing the warning to the occupant when the detection is not an error.

FIG. 7 is a flowchart illustrating a flow of control processing according to the second embodiment. The illustrated control processing is performed by the processor 33 of the ECU 30. It is to be noted that steps S21 to S28 of FIG. 7 are similar to steps S11 to S18 of FIG. 6, and hence description thereof is omitted.

When it is determined in step S24 that the trailer 200 is connected, the operation unit 334 determines whether or not the door is closed and the opening operation of the door is performed by the occupant, based on the detection result from the door sensor 13 (step S29). When it is determined in step S29 that the opening operation of the door is performed by the occupant, the operation unit 334 warns the occupant of the vehicle 100 that the moving body is expected to pass the side of the door (step S30). However, at this time, the operation unit 334 does not restrict the opening of the corresponding door. After that, the operation unit 334 determines whether or not the door is open (step S27), and performs the warning to the occupant when it is determined that the door is open (step S28).

### Modification Example

Next, description is given of a modification example of the vehicle control system 1 according to the first embodiment and the second embodiment described above.

In one modification example, even when it is determined that the trailer 200 is connected to the vehicle 100, the operation unit 334 may perform the contact avoidance operation. Thus, even in this case, the opening of the door of the vehicle 100 may be restricted, and the warning to the vehicle 100 may be performed. However, in this case, when it is determined that the trailer 200 is connected to the vehicle 100, the operation unit 334 does not perform the contact avoidance operation until the moving body comes closer to the vehicle 100 as compared with the case where it is determined that the trailer 200 is not connected to the vehicle 100. Specifically, in this embodiment, when it is determined that the trailer 200 is connected to the vehicle 100, the reference time for use in performing the contact avoidance action is set to be shorter than the case where it is determined that the trailer 200 is not connected to the vehicle 100.

Here, as illustrated in FIG. 5, when the oncoming vehicle X is separated from the front surface of the trailer 200, the millimeter waves are reflected at an acute angle on the front surface of the trailer 200, resulting in erroneous detection. Meanwhile, as the oncoming vehicle X comes closer to the front surface of the trailer 200, in order to recreate the erroneous detection, the millimeter waves are required to be reflected at a large angle on the front surface of the trailer 200, resulting in that the erroneous detection is less liable to be performed. That is, as the oncoming vehicle X comes closer to the front surface of the trailer 200, the erroneous detection is less liable to be performed. Thus, in the above-mentioned modification example, when it is determined that the trailer 200 is connected to the vehicle 100, the contact avoidance operation is not performed until the moving body comes close to the vehicle 100. In this manner, while the contact avoidance operation is prevented from being unnecessarily performed, the necessary restriction of the opening of the door or warning to the occupant can be performed.

It is to be noted that, when it is determined that the trailer 200 is connected to the vehicle 100, the operation unit 334 may restrain the contact avoidance operation by a method different from the first embodiment, the second embodiment, or the modification example described above, as long as the contact avoidance operation is restrained as compared with the case where it is determined that the trailer 200 is not connected to the vehicle 100. For example, when it is determined that the trailer 200 is connected to the vehicle 100, the operation unit 334 may reduce the opening degree at which the door can be opened as compared with the case where it is determined that the trailer 200 is not connected to the vehicle 100.

Exemplary embodiments according to the present disclosure have been described above, but the present disclosure is not limited to the embodiments, and various modifications and changes can be made thereto within the description of the scope of claims.

What is claimed is:

1. A vehicle control device that controls an operation of a vehicle, the vehicle control device comprising:
a moving body detection unit that detects a moving body present behind the vehicle;
an operation unit that performs, when the moving body detected by the moving body detection unit is estimated to pass a side of a door of the vehicle, a contact avoidance operation including at least one of restriction of opening of the door and warning to an occupant of the vehicle; and
a towing determination unit that determines whether a trailer is connected to the vehicle, wherein, when determination is made that the trailer is connected to the vehicle, the operation unit restrains the contact avoidance operation as compared with a case where determination is made that the trailer is not connected to the vehicle.

2. The vehicle control device according to claim 1, wherein, when determination is made that the trailer is connected to the vehicle, the operation unit does not perform the contact avoidance operation.

3. The vehicle control device according to claim 1, wherein, when determination is made that the trailer is connected to the vehicle, the operation unit performs the warning to the occupant of the vehicle but does not restrict the opening of the door.

4. The vehicle control device according to claim 1, wherein, when determination is made that the trailer is connected to the vehicle, the operation unit does not perform the contact avoidance operation until the moving body comes closer to the vehicle as compared with the case where determination is made that the trailer is not connected to the vehicle.

5. A vehicle control method of controlling an operation of a vehicle, the vehicle control method comprising:
detecting a moving body present behind the vehicle;
executing, when the detected moving body is estimated to pass a side of a door of the vehicle, a contact avoidance operation including at least one of restriction of opening of the door and warning to an occupant of the vehicle; and
determining whether a trailer is connected to the vehicle, wherein, when determination is made that the trailer is connected to the vehicle, the contact avoidance operation is restrained as compared with a case where determination is made that the trailer is not connected to the vehicle.
